(19) United States
(12) Patent Application Publication
(10) Pub. No.: US 2011/0141973 A1
(43) Pub. Date: Jun. 16, 2011

(54) METHOD FOR REASSEMBLING MEDIUM ACCESS CONTROL PROTOCOL DATA UNIT AND RECEIVER PERFORMING THE SAME

(75) Inventors: Nak Woon SUNG, Daejeon (KR); Sook Jin Lee, Daejeon (KR)

(73) Assignee: Electronics and Telecommunications Research Institute, Daejeon (KR)

(21) Appl. No.: 12/869,322

(22) Filed: Aug. 26, 2010

(30) Foreign Application Priority Data
Dec. 15, 2009 (KR) 10-2009-012875

(51) Int. Cl. H04W 4/00; H04L 12/56

(52) U.S. Cl. 370/328; 370/394

(57) ABSTRACT

A method for reassembling a medium access control (MAC) protocol data unit (PDU) of a receiver includes: receiving at least one hybrid automatic repeat request (HARQ) burst in an automatic repeat request (ARQ) disabled connection that does not support an ARQ function; extracting at least one fragment from at least one MAC PDU included in at least one HARQ burst; setting a new start point by comparing a predetermined start point with the sequence number of the fragment; and reassembling fragments having sequence numbers before the new start point.

### CROSS-REFERENCE TO RELATED APPLICATION

This application claims priority to and the benefit of Korean Patent Application No. 10-2009-0124875 filed in the Korean Intellectual Property Office on Dec. 15, 2009, the entire contents of which are incorporated herein by reference.

### BACKGROUND OF THE INVENTION

(a) Field of the Invention

The present invention relates to wireless communication. More particularly, the present invention relates to a method and an apparatus for reassembling a medium access control (MAC) protocol data unit (hereinafter referred to as “PDU”) when an automatic repeat request (hereinafter referred to as “ARQ”) function is not supported in a medium access control (hereinafter referred to as “MAC”) layer.

(b) Description of the Related Art

A wireless communication system, e.g., an Institute of Electrical and Electronics Engineers (IEEE) 802.16e system and an IEEE 802.16m system define a hybrid automatic repeat request (HARQ) function to control an error by combining error correction with retransmission in a physical (PHY) layer. In the IEEE 802.16e system, the HARQ function is optional, but in the IEEE 802.16m system, the HARQ function is mandatory. Meanwhile, in various Internet applications including a hypertext transfer protocol (HTTP), a transmission control protocol (TCP) is used as a basic protocol. The TCP performs an operation of transmitting user data without an error end-to-end. For this purpose, a receiver sends an acknowledgment (ACK) for a received TCP segment and a transmitter performs congestion control by performing the retransmission when the transmitter does not receive the ACK. According to the TCP, the receiver transmits the ACK by a cumulative ACK method. In the cumulative ACK method, an ACK number represents a position where the receiver receives and acknowledges data on the flow of the data. That is, the ACK number represents the number of subsequent octets that the transmitter should transmit. According to the cumulative ACK method, a lost ACK packet is not retransmitted. Therefore, even though one ACK package is lost in transmission, all data received up to then can be acknowledged as a subsequent ACK. However, in the case where the subsequent packet arrives or a packet having a wrong sequence number arrives after some packets are lost, the packet that arrives next to the lost packet or the packet having the wrong sequence number is not acknowledged in the receiver. Therefore, the transmitter performs the retransmission.

The IEEE 802.16e system defines a single-carrier operation, while the IEEE 802.16m system defines a multi-carrier operation and operates the HARQ function for each carrier. At this time, in case of the ARQ enabled connection in the MAC layer, an order ensuring method of the service data unit (SDU) and a processing method of each ARQ block in the MAC PDU are defined. However, in case of the ARQ disabled connection in the MAC layer, a method for reassembling the MAC PDU is not disclosed in detail. Accordingly, the ARQ disabled connection requires an efficient method for reassembling the MAC PDU.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for efficiently reassembling a MAC PDU in case of an ARQ disabled connection in a MAC layer.

An exemplary embodiment of the present invention provides a method for reassembling a medium access control (MAC) protocol data unit (PDU) of a receiver, that comprises:

receiving at least one hybrid automatic repeat request (HARQ) burst in an ARQ disabled connection that does not support an automatic repeat request (ARQ) function; extracting at least one fragment from at least one MAC PDU included in at least one HARQ burst; setting a new start point by comparing a predetermined start point with a sequence number of the fragment; and reassembling fragments having sequence numbers before the new start point.

Another embodiment of the present invention provides a receiver that is connected to a transmitter via multiple carriers, that includes:

a fragment extractor extracting at least one fragment from at least one medium access control (MAC) protocol data unit (PDU) included in at least one hybrid automatic repeat request (HARQ) burst in an ARQ disabled connection that does not support an automatic repeat request (ARQ) function; a controller setting a new start point by comparing a predetermined start point with the sequence number of the fragment; and a reassembler reassembling fragments having sequence numbers before the new start point.

Yet another embodiment of the present invention provides a method for processing data in a receiver including multiple physical layers and a medium access control (MAC) layer, that includes:

receiving a HARQ burst from a transmitter; transmitting at least one data unit included in the HARQ burst in the multiple physical layers to the MAC layer; extracting at least one fragment from the data unit in the MAC layer; comparing a predetermined start point with the sequence number of the fragment; and setting a new start point when the sequence number and the predetermined start point are the same as each other and setting a delay time for the fragment when the sequence number and the predetermined start point are not the same as each other.

According to an embodiment of the present invention, when a base station and a terminal simultaneously access multiple carriers and perform a HARQ function for each carrier, it is possible to acquire a method for efficiently reassembling a MAC PDU in an ARQ disabled connection in a MAC layer of a receiver. In particular, it is possible to ensure the order of an SDU and prevent a malfunction and the overflow of a buffer for reassembling the MAC PDU in the receiver.

### BRIEF DESCRIPTION OF THE DRAWINGS

FIG. 1 schematically shows a wireless communication system according to an embodiment of the present invention;

FIG. 2 is a schematic diagram of a MAC PDU according to an exemplary embodiment of the present invention;

FIG. 3 is a schematic block diagram of a receiver according to an embodiment of the present invention;

FIG. 4 is a flowchart showing a method for reassembling a MAC PDU according to an embodiment of the present invention;

FIG. 5 is a flowchart showing a method for reassembling a MAC PDU according to another embodiment of the present invention;

FIG. 6 shows an operation example of reassembling a MAC PDU of a receiver according to an embodiment of the present invention; and

FIG. 7 is a flowchart showing a data processing method according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a mobile station (MS) may designate a terminal, a mobile terminal (MT), a subscriber station (SS), a portable subscriber station (PSS), user equipment (UE), an access terminal (AT), etc., and may include the entire or partial functions of the terminal, the mobile terminal, the subscriber station, the portable subscriber station, the user equipment, the access terminal, etc.

In the specification, a base station (BS) may designate an access point (AP), a radio access station (RAS), a node B, an evolved node B (eNodeB), a base transceiver station (BTS), a mobile multihop relay (MMR)-BS, etc., and may include the entire or partial functions of the access point, the radio access station, the node B, the evolved node B, the base transceiver station, the MMR-BS, etc.

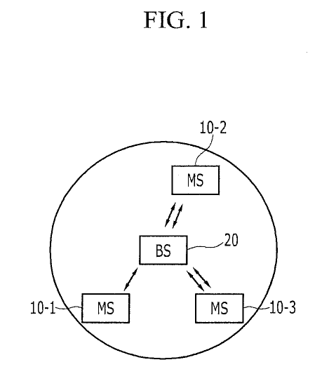

FIG. 1 schematically shows a wireless communication system according to an embodiment of the present invention.

Referring to FIG. 1, the wireless communication system includes a base station 20 and terminals 10-1, 10-2, and 10-3, and the base station 20 provides a communication service to a predetermined geographical area (referred to as a “cell”). A plurality of carriers may be operated in the cell of the wireless communication system. At this time, terminals may access a single carrier or multiple carriers. For example, the terminal 10-1 may access a single carrier and the terminals 10-2 and 10-3 may access multiple carriers. At the time of accessing the multiple carriers, the terminals 10-2 and 10-3 and the base station 20 use multiple physical (PHY) layers and a single common MAC layer, respectively. In the physical layer, channel coding and modulation/demodulation may be performed for each carrier, and a multi-input multi-output (MIMO) function may also be operated for each carrier.

In the wireless communication system, a connection of the MAC layer may be divided into an ARQ enabled connection and an ARQ disabled connection. The connection of the MAC layer may be established by negotiation between the terminal and the base station on the basis of a quality of service (QOS).

In the ARQ disabled connection, the MAC PDU transmitted from a HARQ functioning unit of the physical layer or a processing method of fragments included in the MAC PDU is not defined. In general, a HARQ burst may be retransmitted on the basis of a channel state. At this time, in order to ensure the order of the MAC PDU, the HARQ functioning unit of the receiver has complicated functions and requires a large amount of memory. Further, in case of supporting the multiple carriers, since the HARQ function is progressed for each carrier, the order of the MAC PDU cannot be ensured due to the retransmission in each HARQ functioning unit.

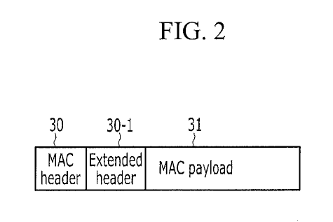

Hereinafter, in case of the ARQ disabled connection in the MAC layer, the apparatus and method for reassembling the MAC PDU will be described in detail with reference to FIGS. 2 to 7.

FIG. 2 is a schematic diagram of a MAC PDU according to an embodiment of the present invention.

Referring to FIG. 2, the MAC PDU includes a MAC header 30 and a MAC payload 31. The MAC header 30 is positioned prior to the MAC payload 31 and may further include an extended header 30-1. The MAC payload 31 includes at least one MAC SDU or a fragment derived from one MAC SDU. Reassembling the MAC PDU includes generating the MAC SDU for transmission to an upper layer. Hereinafter, the transmitter may be a part of the base station in a downlink and a part of the terminal in an uplink. The receiver may be a part of the terminal in the downlink and a part of the base station in the uplink.

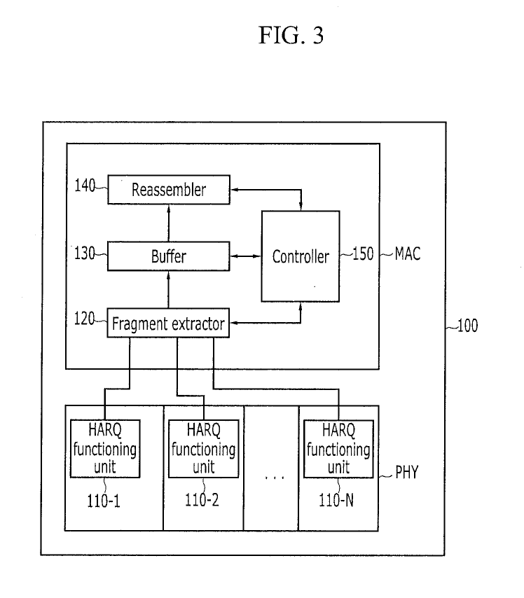

FIG. 3 is a schematic block diagram of a receiver according to an embodiment of the present invention.

Referring to FIG. 3, a receiver 100 includes a multiple physical layer and a common MAC layer. The multiple physical layer includes a plurality of HARQ functioning units 110-1, 110-2, . . . , 110-N, and the common MAC layer includes a fragment extractor 120, a buffer 130, a reassembler 140, and a controller 150.

The plurality of HARQ functioning units 110-1, 110-2, . . . , 110-N correspond to the multiple carriers, respectively. That is, each of the plurality of HARQ functioning units 110-1, 110-2, . . . , 110-N performs the HARQ function for each corresponding carrier. Each of the plurality of HARQ functioning units 110-1, 110-2, . . . , 110-N defines a plurality of HARQ channels, e.g., at most sixteen HARQ channels. Each of the plurality of HARQ functioning units 110-1, 110-2, . . . , 110-N can receive a plurality of HARQ bursts for each frame. Herein, each of the HARQ bursts includes a plurality of PDUs. The HARQ functioning units 110-1, 110-2, . . . , 110-N output the MAC PDU included in the received HARQ burst.

When the terminals 10-2 and 10-3 and the base station 20 operate as a transmitter, each HARQ functioning unit can transmit the plurality of HARQ bursts for each frame. When an error occurs, the HARQ bursts from each HARQ functioning unit may be retransmitted as many as the maximum retransmission number of times (T_MAX_ReTx). Each retransmission is performed within a retransmission time (T_ReTx_Interval). Herein, the retransmission time and the maximum retransmission number of times may depend on whether frequency division duplex (FDD) or time division duplex (TDD) is used, whether it is an uplink or a downlink, frame duration, a subframe type, and an advanced MAP (A-MAP) allocation cycle.

The fragment extractor 120 extracts the fragment from the MAC PDU received from the HARQ functioning units 110-1, 110-2, . . . , 110-N. The controller 150 compares the sequence number of the fragment extracted from the fragment extractor 120 with a predetermined start point, and according to the comparison result, when the sequence number of the fragment and the start point are the same as each other, the controller 150 sets a new start point. When the sequence number of the fragment and the start point are not the same as each other, the controller 150 sets a predetermined delay time for the corresponding fragment. The buffer 130 stores the fragment extracted from the fragment extractor 120 for the predetermined delay time. The transmitter and the receiver may share information on the size of the buffer 130. The controller 150 verifies whether or not the delay time has elapsed for the fragment stored in the buffer 130. When the delay time for the corresponding fragment has elapsed, the controller 150 sets a new start point. The reassembler 140 reassembles the MAC PDU for the fragment of which the start point and the sequence number are the same as each other and/or the predetermined delay time has elapsed. A fragment that cannot be reassembled may be discarded in the reassembler 140. In some cases, the fragment that cannot be reassembled may be discarded in the buffer 130 without being inputted into the reassembler 140.

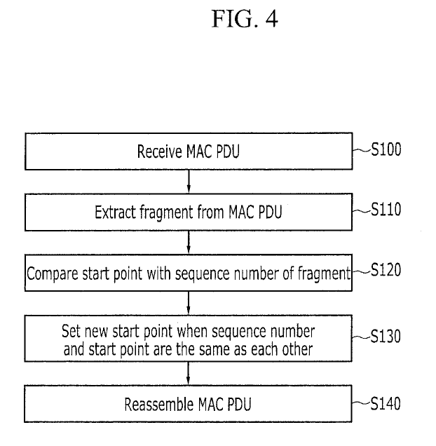

FIG. 4 is a flowchart showing a method for reassembling a MAC PDU according to an embodiment of the present invention.

Referring to FIG. 4, the MAC layer of the receiver receives at least one MAC PDU from at least one HARQ functioning unit 110-1, 110-2, . . . , or 110-N of the multi-physical layer (S100). In the multi-physical layer, since the HARQ function is performed for each carrier, the MAC PDU may be transmitted from each of the plurality of HARQ functioning units 110-1, 110-2, . . . , 110-N.

The fragment extractor 120 of the MAC layer extracts at least one fragment from the MAC PDU (S110). The controller 150 of the MAC layer compares the predetermined start point (RX_START) with the sequence number (SN) of the fragment (S120). The sequence number of the fragment may be stored in the extended header such as the MAC header, e.g., a fragmentation and packing extended header (FPEH), a fragmentation extended header (FEH), a multiplexing extended header (MEH), etc. The start point may be a first fragment that is not received.

When the sequence number of the fragment and the start point are the same as each other according to the comparison result at step S120, the controller 150 of the MAC layer sets a new start point (S130). The new start point may be the sequence number of a fragment that is not firstly received after the fragment of which the sequence number and the start point are the same as each other.

The reassembler 140 of the MAC layer reassembles fragments before the new start point (S140). According to the reassembling result, when the MAC SDU is generated, the generated MAC SDU is transmitted to the upper layer. However, fragments that cannot be reassembled into the MAC SDU may be discarded.

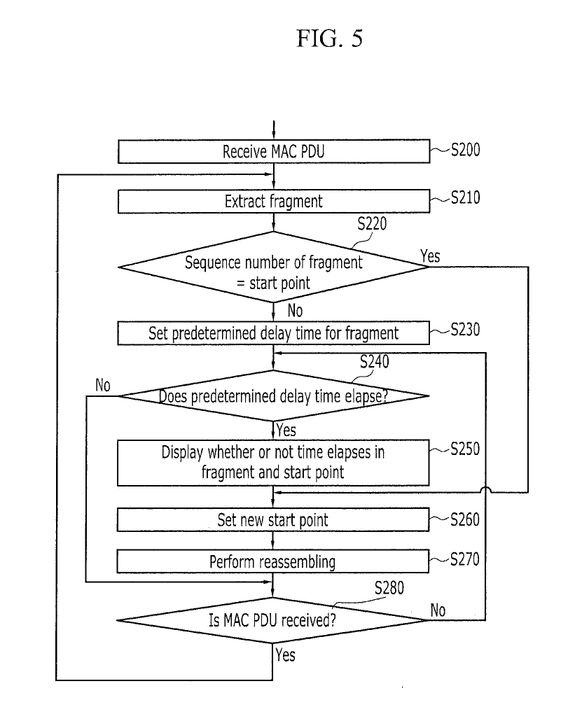

FIG. 5 is a flowchart showing a method for reassembling a MAC PDU according to another embodiment of the present invention.

Referring to FIG. 5, the MAC layer of the terminal receives at least one MAC PDU from at least one HARQ functioning unit 110-1, 110-2, . . . , or 110-N of the multi-physical layer (S200).

The fragment extractor 120 of the MAC layer extracts at least one fragment from the MAC PDU (S210). The controller 150 of the MAC layer compares the predetermined start point with the sequence number of the fragment (S220). When the sequence number of the fragment and the start point are the same as each other according to the comparison result at step S220, the controller 150 of the MAC layer sets a new start point (S260). On the contrary, when the sequence number of the fragment is not the same as the start point, the controller 150 of the MAC layer sets a predetermined delay time (RX_PURGE_TIMEOUT) for the corresponding fragment and stores the corresponding fragment in the buffer 130 for a predetermined delay time (S230). For example, when the start point is set to n, the receiver sets a delay time for a fragment #n+1 and sets the fragment #n+1 in the buffer 130 for the delay time. The delay time may be set on the basis of a retransmission time which is a time from when the transmitter firstly transmits the HARQ burst to when the transmitter retransmits the HARQ burst or a time from when the receiver transmits a not-acknowledgement (NACK) to when the transmitter retransmits the HARQ burst, and the maximum retransmission number of times. The delay time may be set a larger value than, for example, a value of a product of the retransmission time and the maximum retransmission number of times. The retransmission time and the maximum retransmission number of times may be set by considering at least one of a duplex mode, whether it is an uplink or a downlink, a frame duration, a subframe type, and an advanced MAP (A-MAP) allocation cycle. The delay time is set for each fragment.

The controller 150 of the MAC layer verifies whether or not the delay time for the fragment stored in the buffer 130 has elapsed (timeout) (S240). When the delay time for the corresponding fragment has elapsed according to the verification result, a timeout state is marked for the corresponding fragment and start point (S250). When the delay time for the corresponding fragment has elapsed, steps S200 to S240 are repeated if the MAC layer of the receiver receives a new MAC PDU and step S240 for the corresponding fragment is repeated if the new MAC PDU is not received.

The controller 150 of the MAC layer sets the sequence number of a fragment that is not firstly received after the fragment (i.e., fragment #n+1) of which the delay time has elapsed as the new start point (S260). The reassembler 140 of the MAC layer sequentially reassembles the MAC PDU for the fragments up to the new start point (RX_START) (S270). According to the reassembling result, when the MAC SDU is generated, the generated MAC SDU is transmitted to the upper layer. However, the fragments that cannot be reassembled into the MAC SDU may be discarded. Thereafter, the MAC layer verifies whether or not the new MAC PDU is received, and if the new MAC PDU is received, steps S210 to S270 are performed again, and if the new MAC PDU is not received, the MAC layer verifies whether or not the delay time has elapsed for the fragments stored in the buffer 130 again.

Reassembling the MAC PDU may be performed for each connection. In particular, in the case where the MEH header is used as the sequence number of the fragment, the MEHB header may be used for each corresponding flow identifier (flow ID).

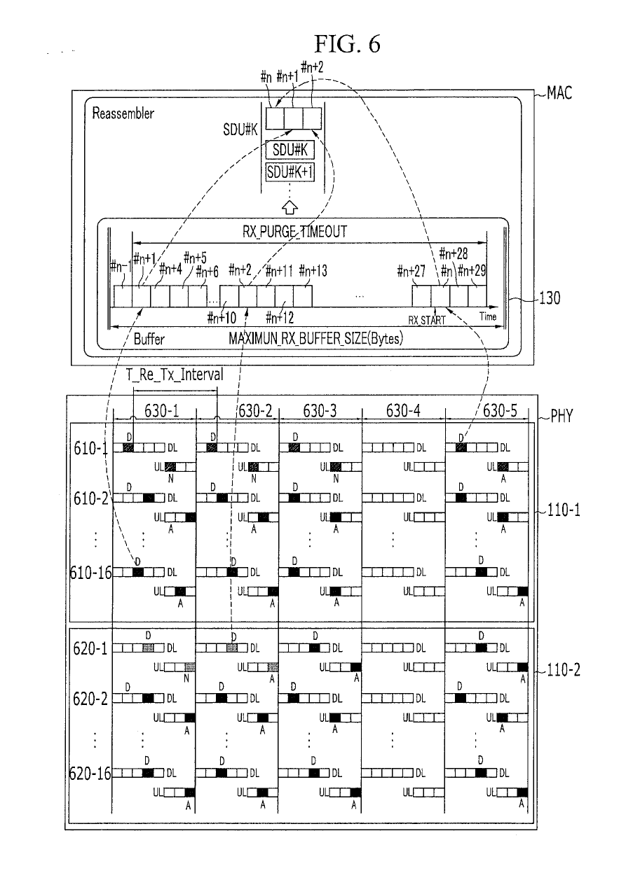

FIG. 6 shows an operation example of reassembling a MAC PDU of a receiver according to an embodiment of the present invention. The receiver simultaneously accesses two carriers.

Referring to FIG. 6, each of the HARQ functioning units 110-1 and 110-2 is constituted by 16 HARQ channels, and the HARQ channel may be a stop-and-wait channel, for example. Each of the HARQ functioning unit 110-1 and 110-2 of the multi-physical layer of the receiver receives the HARQ bursts through the plurality of HARQ channels for each frame, and the MAC PDU of the HARQ burst received through each of the HARQ functioning units 110-1 and 110-2 is transmitted to the common MAC layer. The fragment extractor 120 of the common MAC layer extracts the fragment from the MAC PDU and stores the fragment extracted from the buffer 130.

In FIG. 6, it is assumed that SDU #K is transmitted from the MAC layer to three fragments (i.e., fragment #n, fragment #n+1, and fragment #n+2) of the upper layer, and fragments before fragment #n are successively received and reassembled. Therefore, the start point (RX_START) is the sequence number of the first fragment that is not received, and the start point is n.

Fragment #n is transmitted through a first HARQ channel (1^{st} HARQ CH, 610-1) for a first carrier, fragment #n+1 is transmitted through a sixteenth HARQ channel (16^{th} HARQ CH, 610-16) of the HARQ functioning unit 110-1 for the first carrier, and fragment #n+2 is transmitted through the first HARQ channel (620-1) of the HARQ functioning unit 110-2 for the second carrier. At this time, it is assumed that fragment #n+1 is successively received without being retransmitted after the first transmission in an i-th frame (630-1), fragment #n+2 is retransmitted in an i+1-th frame (630-2) after the first transmission and successively received in the i-th frame (630-1), and fragment #n is retransmitted as many as the maximum retransmission number of times (N_MAX_ReTx) after the first transmission in the i-th frame (630-1) and received in an (i+j)-th frame (630-5).

First, the MAC layer of the receiver receives fragment #n+1 and compares the start point n with the sequence number (n+1) of the fragment. Since the sequence number (n+1) of the fragment and the start point n are the same as each other, the receiver sets a predetermined delay time for fragment #n+1, and stores fragment #n+1 in the buffer 130 for the delay time. Herein, the size of the buffer 130 may be expressed by the unit of time. The delay time may be set by considering the retransmission time (T_ReTx_Interval) and the maximum retransmission number of times (N_MAX_ReTx).

Next, the MAC layer of the receiver receives fragment #n+2 and compares the start point n with the sequence number (n+2) of the fragment. Since the sequence number (n+2) of the fragment and the start point n are not the same as each other, the receiver sets a predetermined delay time for fragment #n+2 and stores fragment #n+2 in the buffer 130 for the delay time.

Next, the MAC layer of the receiver receives fragment #n and compares the start point n with the sequence number (n) of the fragment. Since the sequence number (n) of the fragment and the start point (n) are the same as each other, the terminal sets the new start point and reassembles the MAC PDU for a fragment before the new start point. The new start point may be a fragment that is not firstly received after fragment #n. When fragment #n is received to the MAC layer before the predetermined delay time of each of the fragment #n+1 and fragment #n+2 has elapsed, the MAC PDU for SDK #K may be successively reassembled in the MAC layer.

Meanwhile, when fragment #n is not received to the MAC layer even after the delay time of each of fragment #n+1 and fragment #n+2 has elapsed, the MAC layer of the receiver sets the new start point and may discard both fragments #n+1 and #n+2 constituting the SDU #K.

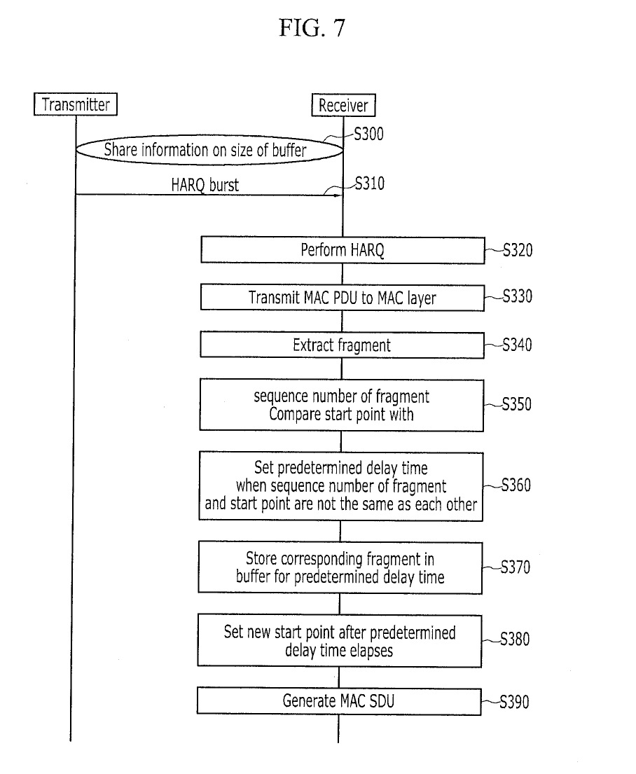

FIG. 7 is a flowchart showing a data processing method according to an embodiment of the present invention.

Referring to FIG. 7, the transmitter and the receiver share the information on the size of the buffer 130 for storing the MAC PDU that is waiting for reassembling (S300). The size of the buffer may be previously set by negotiation between the base station and the terminal. The size of the buffer may be set on the basis of the channel state. The channel state can be known by using a signal to noise ratio (SNR), a signal to interference and noise ratio (SINR), a channel quality indicator (CQI), etc.

The transmitter transmits the HARQ burst to the receiver (S310). The HARQ functioning units 110-1, 110-2, . . . , 110-N of the receiver perform the HARQ function for the received HARQ burst (S320) and transmit the MAC PDU to the MAC layer (S330).

The fragment extractor 120 of the MAC layer extracts at least one fragment from the received MAD PDU (S340), and the controller 150 of the MAC layer compares the start point with the sequence number of the fragment (S350). When the sequence number of the fragment and the start point are the same as each other, the controller 150 of the MAC layer sets the new start point. When the sequence number of the fragment and the start point are not the same as each other, the controller 150 of the MAC layer sets a predetermined delay time for the corresponding fragment (S360) and stores the corresponding fragment in the buffer 130 for the delay time (S370). By step S300, the transmitter knows the size of the buffer of the receiver. Accordingly, the transmitter can prevent an overflow of the buffer by controlling the transmission speed of the HARQ burst. After the delay time has elapsed, the controller 150 of the MAC layer sets the new start point (S380) and the reassembler 140 of the MAC layer reassembles fragments before the new start point to generate the MAC SDU (S390).

As a result, in the case where the transmitter and the receiver simultaneously access the multiple carriers and the HARQ function of the receiver is performed for each carrier, it is possible to ensure the sequence of the MAC SDU transmitted to the upper layer from the MAC layer and it is possible to prevent a malfunction and overflow of the buffer for storing the fragment of the MAC PDU.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for reassembling a medium access control (MAC) protocol data unit (PDU) of a receiver, comprising:
receiving at least one hybrid automatic repeat request (HARQ) burst in an ARQ disabled connection that does not support an automatic repeat request (ARQ) function;
extracting at least one fragment from at least one MAC PDU included in at least one HARQ burst;
setting a new start point by comparing a predetermined start point with a sequence number of the fragment; and
reassembling fragments having sequence numbers before the new start point.

2. The method of claim 1, wherein
the new start point is the sequence number of a fragment that is not firstly received after the predetermined start point.

3. The method of claim 1, wherein
the setting the new start point comprises:
setting the new start point when the sequence number and the start point are the same as each other.

4. The method of claim 1, wherein
the setting the new start point comprises:
setting a delay time for the fragment when the sequence number and the predetermined start point are not the same as each other;
maintaining the fragment in a buffer for the delay time; and
setting the new start point when the delay time elapses.

5. The method of claim 4, wherein
the delay time is set on the basis of a retransmission time and a maximum retransmission number of times of a transmitter.

6. The method of claim 5, wherein
the retransmission time is a time from when the transmitter firstly transmits the HARQ burst to when the transmitter retransmits the HARQ burst or a time from when the receiver transmits a not-acknowledgement (NACK) to when the transmitter retransmits the HARQ burst corresponding to the NACK.

7. The method of claim 1, wherein
the reassembling comprises discarding the fragment that are not reassembled.

8. The method of claim 1, wherein
the sequence number of the fragment is stored in an extended header of the MAC PDU including the fragment.

9. The method of claim 1, wherein
the receiver is connected to a transmitter via multiple carriers,
the receiver includes multiple physical layers receiving the HARQ burst and a medium access layer receiving the MAC PDU from the multiple physical layers, and
in the multiple physical layers, a HARQ function is performed for each carrier.

10. A receiver that is connected to a transmitter via multiple carriers, comprising:
a fragment extractor extracting at least one fragment from at least one medium access control (MAC) protocol data unit (PDU) included in at least one hybrid automatic repeat request (HARQ) burst in an automatic repeat request (ARQ) disabled connection that does not support an ARQ function;
a controller setting a new start point by comparing a predetermined start point with the sequence number of the fragment; and
a reassembler reassembling fragments having sequence numbers before the new start point.

11. The receiver of claim 10, wherein
the controller sets the new start point when the sequence number and the predetermined start point are the same as each other.

12. The receiver of claim 10, wherein
the controller sets a delay time for the fragment when the sequence number and the predetermined start point are not the same as each other.

13. The receiver of claim 12, further comprising
a buffer storing the fragment of which the sequence number is not the same as the predetermined start point for the delay time.

14. The receiver of claim 13, wherein
information on the size of the buffer is shared with the transmitter.

15. The receiver of claim 10, wherein
the reassembler discards the fragment that are not reassembled.

16. A method for processing data in a receiver including multiple physical layers and a medium access control (MAC) layer, comprising:
receiving a HARQ burst from a transmitter;
transmitting at least one data unit included in the HARQ burst in the multiple physical layers to the MAC layer;
extracting at least one fragment from the data unit in the MAC layer;
comparing a predetermined start point with the sequence number of the fragment; and
setting a new start point when the sequence number and the predetermined start point are the same as each other and setting a delay time for the fragment when the sequence number and the predetermined start point are not the same as each other.

17. The method of claim 16, further comprising
reassembling fragments before the new start point.

18. The method of claim 16, further comprising:
storing the fragment of which the sequence number is not the same as the start point for the delay time; and
reassembling the fragment stored in the buffer when the delay time elapses for the fragment stored in the buffer.

19. The method of claim 18, further comprising
sharing information on the size of the buffer with the transmitter.
